(19) United States
(12) Patent Application Publication
(10) Pub. No.: US 2003/0128748 A1
(43) Pub. Date: Jul. 10, 2003

(54) Path search for CDMA implementation

(76) Inventors: Rasekh Rifaat, Brookline, MA (US); Zvi Greenfield, Kfar Sava (IL); Haim Primo, Gane Tikwa (IL)

Correspondence Address: Samuels, Gauthier & Stevens LLP, Suite 3300, 225 Franklin Street, Boston, MA, 02110, US

(21) Appl. No.: 10/313,307

(22) Filed: Dec. 6, 2002

Related U.S. Application Data
(60) Provisional application No. 60/347,767, filed on Jan. 10, 2002.

(51) Int. Cl. H04K 1/00

(52) U.S. Cl. 375/148

(57) ABSTRACT

A digital signal processor performs path search calculations for a Rake receiver. Despread operations are performed for multiple relative delays over a subcorrelation length by shifting either received chips or code chips for each relative delay. The result of a despread operation for a relative delay is added to the result of previous despread operations of the same delay performed on prior subcorrelation lengths. These calculations are performed in response to a single instruction. By issuing multiple instructions, path search calculations are performed for the entire correlation length.

### PRIORITY INFORMATION

This application claims priority from provisional application Ser. No. 60/347,767 filed Jan. 10, 2002, which is incorporated herein by reference in its entirety.

### BACKGROUND OF THE INVENTION

The invention relates to the field of digital signal processors, and, in particular, to digital signal processors processing signals in a Code Division Multiple Access system.

Code Division Multiple Access (CDMA) is a wireless communications technology that uses a technique called spread spectrum to transmit multiple signals on the same frequency. There is a need for next generation CDMA equipment to be flexible so that the equipment can grow with the demands of consumers and the concomitant need of service providers. Almost all aspects of CDMA processing require intensive computations. This computational intensity has resulted in most aspects of CDMA processing being performed in specialized circuits. These specialized circuits, however, do not provide the flexibility needed when processing CDMA signals.

Generally, in a CDMA system, the bits to be transferred are first mapped to predetermined points on a complex plane. FIG. 1a illustrates an exemplary complex mapping in which a single bit is mapped to a single point. For the mappings shown in FIG. 1a, each bit is replaced by the complex value to which it maps. For instance, the bit sequence:

0010011100

would become:

(1)(1)(−1)(1)(1)(−1)(−1)(−1)(1)(1).

If it is desired to provide greater transmission rates, a point on the complex plane may represent multiple bits. FIG. 1b illustrates an example where a point on the complex plane represents bit pairs. As can be seen, the point 1+j on the complex plane represents the bit pair 00. Point −1+j on the complex plane represents the bit pair 10. Point −1+−j on the complex plane represents the bit pair 11. Point 1+−j on the complex plane represents the bit pair 01. Thus, for the mapping shown in FIG. 1b, the bits to be transmitted are broken into bit pairs and the pairs are replaced by the complex values. For instance, the bit sequence:

0010011100

would become:

(1+j)(−1+j)(1+−j)(−1+−j)(1+j).

Regardless of the number of bits represented, the resulting complex values are known as symbols. A symbol is normally transmitted using quadrature transmission, in which two signals in phase quadrature are used to represent the complex value. Because of the way quadrature transmission is performed, the imaginary portion of the complex value is normally referred to as the quadrature (Q) portion, while the real portion is referred to as the in-phase (I) portion.

In a CDMA system, these symbols are multiplied by a higher rate, periodic, complex spreading code (chip code) prior to transmission to create a signal with a higher bandwidth than would normally be generated by the symbols, but with the same energy. This is known as spreading. The discrete values in this coded signal, and, similarly, in the complex code, are normally referred to as chips to distinguish them from the bits to be transmitted. The coded signal is then transmitted on the same frequency as other similarly coded signals. The other similarly coded signals, however, use different chip codes. The chip codes for each of the different coded signals are normally chosen to be orthogonal to one another. This allows a receiver to separate out a specific coded signal from all of the coded signals received.

To separate out a specific coded signal, the received signals are cross-correlated with the same chip code that the specific coded signal was coded with. This is known as despreading. Because of the orthogonal nature of the chip codes, cross-correlation of the chip code with the received signals ideally results in a zero for all signals except for the signal generated with the same chip code. For the signal generated with the same chip code, the result is non-zero, with the sign generally giving the value of the transmitted bit.

Separating out a specific coded signal, however, is not possible unless the chip codes in the transmitter and receiver are synchronized. When the transmitter and receiver are not synchronized, the chip period in the coded signal will not be aligned with the chip code period at the receiver. This produces a low correlation between the particular channel to be separated and the despreading code, which results in the specific coded signal not being separated out of the received signal.

In order to more effectively separate out the specific coded signal, CDMA systems use multi-path diversity to overcome degradation due to channel fading. When a coded signal is transmitted, copies of the coded signal follow different paths before arriving at the receiver. An example of this effect is shown FIG. 2. As shown, when transmitter 200 transmits a coded signal, copies of the coded signal travel different paths to a receiver 202. One of the copies follows a direct path 1 from transmitter 200 to receiver 202. A second copy follows an indirect path 2, while a third copy follows an indirect path 3.

Because each copy travels a different path to the receiver, the received signal consists of multiple copies of the coded signal, each experiencing a different path delay and amplitude. A receiver in a CDMA system takes advantage of this multi-path diversity by resolving two or more of the multi-path components of the received signal and combining them to provide a better estimate of the coded signal. A receiver structure that performs this function is known as a Rake receiver.

FIG. 3a illustrates the general structure of a Rake receiver 300. Rake receiver structure 300 has a number of fingers 302, 304 and 306, each of which resolves one of the multi-path components of the received signal. To resolve a multi-path component, the received signal is provided to each finger 302, 304 and 306. Each finger 302, 304 and 306 despreads the received signal by multiplying the received signal times the chipping code with a relative delay between the received signal and chipping code. The relative delay between the received signal and chipping code causes the period of the chipping code and one of the multi-path components to be synchronized, resulting in that multi-path component being resolved. Each finger 302, 304, and 306 has a different relative delay between the received signal and chipping code. Therefore, each finger resolves a different one of the multi-path components. The resolved multi-path component in each finger is then subject to channel correction based upon estimates of the channel parameters. A combiner 308 then combines the corrected multi-path components to achieve a better estimate of the coded signal.

This technique is conceptually illustrated in FIG. 3b. FIG. 3b illustrates the case in which the relative delay is introduced by delaying the chipping code. As will be appreciated by one of skill in the art, the relative delay can also be introduced by delaying the received signal. As shown, the received signal 310 consists of the signals from paths 1, 2 and 3, each with a different path delay. In finger 302, the chipping code from the code generator is delayed by an amount d1, so that the period in the signal from path 1 is synchronized to the chipping code period. Thus, when the chipping code is cross-correlated with the received signal, the signal from path 1 is resolved. Likewise, the chipping code from the code generator is delayed by an amount d2 and d3 in fingers 304 and 306. These delays align the chipping code period in finger 304 with the period in the signal from path 2 and the chipping code period in finger 306 with the period in the signal from path 3. Hence, path 2 is resolved in finger 304 when the received signal and chipping code are cross-correlated, while path 3 is resolved in finger 306.

FIG. 4 illustrates the general processing to accomplish despreading when using a Rake receiver. In order to perform the despreading, the relative delays for each path have to be determined and provided to the corresponding finger. This is generally known as the path search 402. Generally, a Rake receiver is designed as an m-finger receiver and the path search determines the m delays that resolve the highest quality multi-path components.

Channel estimation 404 is then performed using the determined finger delays. A known pilot signal is normally transmitted for estimating channel effects. The finger delays are used to resolve the known pilot signal on each path. The pilot signal received on each path is then compared to a copy of the pilot signal to determine the channel parameters of the paths. The finger delays and channel parameters are then passed to the Rake receiver 406, which performs despreading of the received signal against the chipping code.

Prior art CDMA receivers have implemented the path search in application specific integrated circuits (ASICs) or field-programmable gate arrays (FPGAs) because digital signal processors (DSPs) have had difficulty performing the high-speed complex calculations needed to perform a path search. Implementations using ASICs and FPGAs, however, suffer from a lack of programmability or insufficient programmability.

### SUMMARY OF THE INVENTION

One aspect of the present invention provides a digital signal processor that, in response to a single instruction, performs multiple despread operations on received chips and code chips in a CDMA system, where the received chips and the code chips are shifted relative to each other for each of the despread operations.

Another aspect of the present invention provides a digital signal processor that, in response to a single instruction, iteratively performs the steps of: multiplying received chips in a first storage area times code chips in a second storage area and summing the results and shifting either the received chips or the code chips to provide a relative shift there between.

Another aspect of the present invention provides a digital signal processor comprising a first storage area to hold complex values representative of received chips in a CDMA system, a second storage area to hold complex values representative of code chips in a CDMA system, and a complex multiply-add unit to multiply complex values in the first storage area times complex values in the second storage area and to sum the results. The multiply-add unit performs a plurality of multiplications on the complex values in the first and second storage areas and either the first or second storage area shifts the complex values stored therein after each multiplication.

Another aspect of the present invention provides a method of using a digital signal processor for performing path search calculations to determine finger delays for a Rake receiver in a CDMA system. The method comprises the steps of:

issuing one or more instructions to load a register with received chip values;

issuing one or more instructions to cause a digital signal processor to load a register with code chip values; and

issuing a single instruction to despread the received chip values against the code chip values multiple times with a relative shift between the received chips and code chips each time the received chips are despread against the code chips.

### BRIEF DESCRIPTION OF THE DRAWINGS

FIG. 1a illustrates an exemplary complex mapping in which a single bit is mapped to a point on the complex plane;

FIG. 1b illustrates an exemplary complex mapping where a point on the complex plane represents bit pairs;

FIG. 2 shows a coded signal following different paths before arriving at the receiver;

FIG. 3a illustrates the general structure of a Rake receiver;

FIG. 3b illustrates resolving multi-path components a delayed chipping code;

FIG. 4 illustrates the general processing to accomplish despreading when using a Rake receiver;

FIG. 5 conceptually illustrates calculating correlation values for relative delays using shifted code chips;

FIG. 6 illustrates an exemplary DSP architecture for practicing the features of the present invention;

FIG. 7 illustrates accelerator components used to implement a PATHDESPREAD instruction;

FIG. 8 illustrates the structure of register Rmq, register THr and one of the accumulator registers that provides for calculations over a subcorrelation length of 8 chips and 32 delays;

FIG. 9 illustrates a flow diagram for a single despread operation performed as part of the PATHDESPREAD instruction;

FIG. 10 illustrates a PATHDESPREAD instruction performed for 8 delays;

FIG. 11 illustrates a PATHDESPREAD instruction performed on a subsequent subcorrelation length.

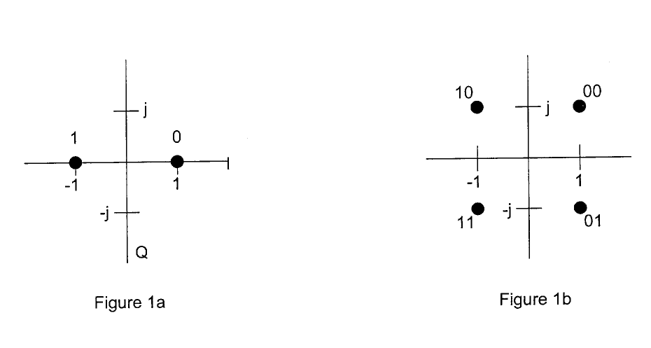

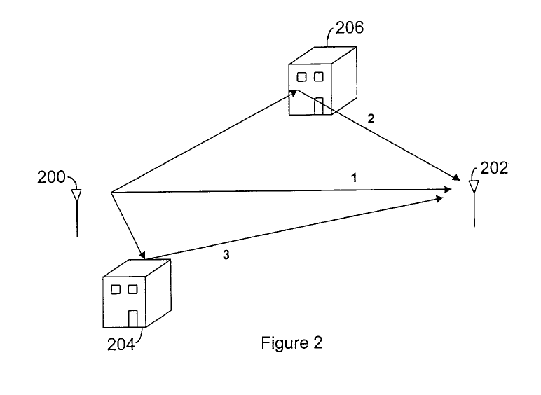

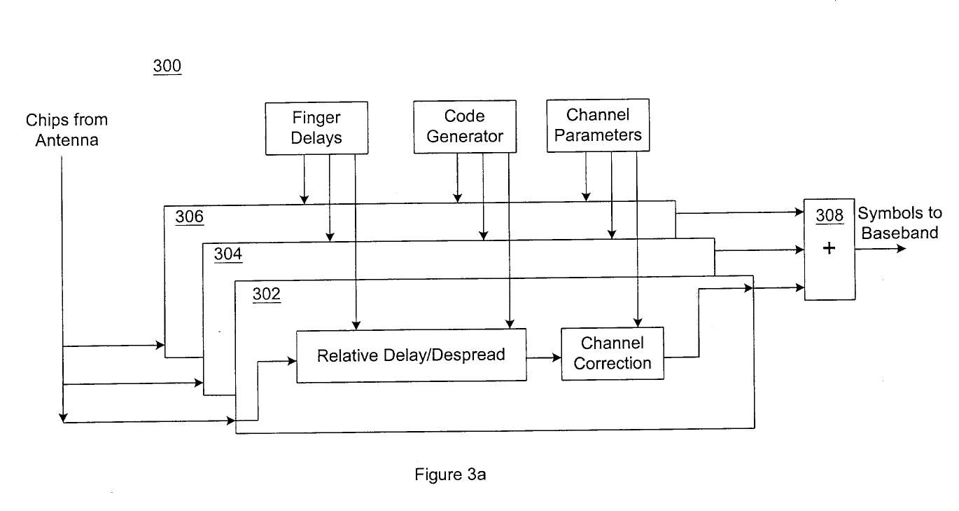

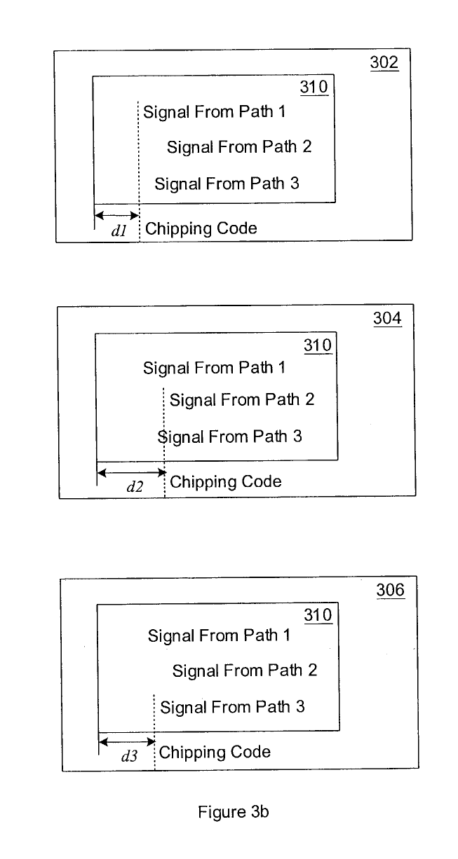

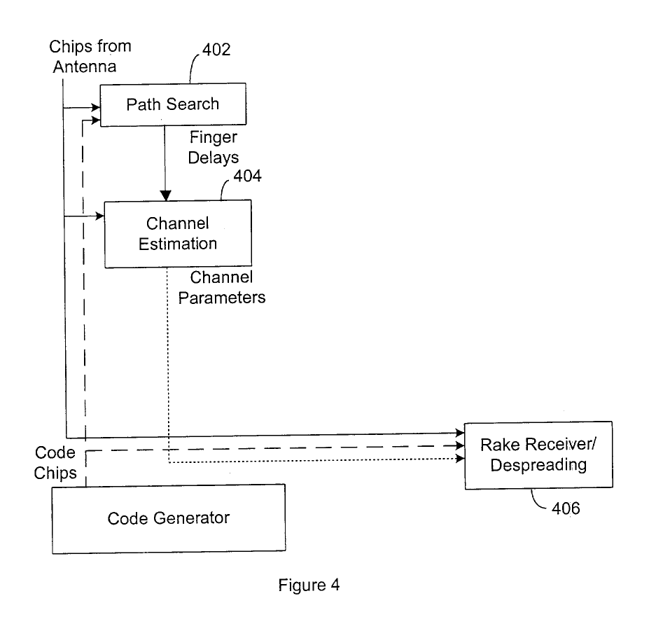

### DETAILED DESCRIPTION OF THE INVENTION

Generally, the path search algorithm searches for the relative delays that resolve the two or more highest quality multi-path components out of the received signal. To do this, a number of relative delays between the chipping code and the received signal are evaluated. Each relative delay value is evaluated by despreading the received signal with the chipping code using that relative delay. This generates a correlation value for each relative delay. The m relative delays with the highest correlation would then typically be used for the m fingers of the Rake receiver. Thus, the path search is a cross-correlation block in which the correlation is performed for each relative delay to be evaluated. Correlation is defined as a multiply and accumulate operation over a correlation length, hence, the correlation y[n] for each delay n to be evaluated is:

$$y [ n ] = {\sum }_{k = 0}^{C} x [ n + k ] d [ k ] , 0 \leq n < {N}_{d} \qquad ( 1 )$$

where x[k] are the code chips, d[k] are the received data chips, C is the correlation length and N_{d} is the number of relative delays.

As described, and as can be seen by equation (1), the path search is a number of despread operations with different relative delays between the received chips and the code chips for each despread operation. The process of despreading is computationally intensive. Several complex multiply and accumulate calculations are needed to perform a single despread operation. These calculations must be performed at a rate greater than or equal to the rate the chips are received. Performing the path search requires a proportionate increase in the number of calculations on the same received chips that must be done. For a DSP, in addition to the time taken to perform the additional calculations, an increase in calculations entails an increase in the bandwidth needed to provide data to the computation block of the DSP. As a consequence of these increased computations, and the high data rates typically used in CDMA systems, DSPs have not previously been able to perform these path search calculations at the requisite rates.

However, the present invention allows a DSP to implement the calculations at the requisite rates. The multiply and accumulate operation of the path search is subdivided:

$$y [ n ] = {\sum }_{j = 0}^{{C}_{d}} {\sum }_{k = 0}^{{C}_{s}} x [ n + k + {jC}_{s} ] d [ k + {jC}_{s} ] , 0 \leq n < {N}_{d} \qquad ( 2 )$$

where Cₛ is a correlation subsize and C_{d}=C/Cₛ, which is the number of subcorrelations that need to be executed. When the inner sum is written as:

$${D}_{{C}_{s} , j} [ n ] = {\sum }_{k = 0}^{{C}_{s}} x [ n + k + {jC}_{s} ] d [ k + {jC}_{s} ] = \\ {\sum }_{k = n}^{{C}_{s} + n} x [ k + {jC}_{s} ] d \{ k - n + {jC}_{s} ] , 0 \leq n < {N}_{d} \qquad ( 3 )$$

it can be seen that the despread operation for each relative delay in a subcorrelation length can be calculated using either shifted received chips or shifted code chips. Hence, storing either the code chips or data chips in a shift-accessible manner allows the despread operations in a subcorrelation length to be performed in a DSP without requiring a proportionate increase in the bandwidth needed to feed the data to the computational unit. This permits a DSP to perform these calculations at a rate required by CDMA systems.

Thus, to calculate the correlation y[n] for each delay n:

$$y [ n ] = {\sum }_{j = 0}^{{C}_{d}} {D}_{{C}_{s} , j} [ n ] , 0 \leq n < {N}_{d} \qquad ( 4 )$$

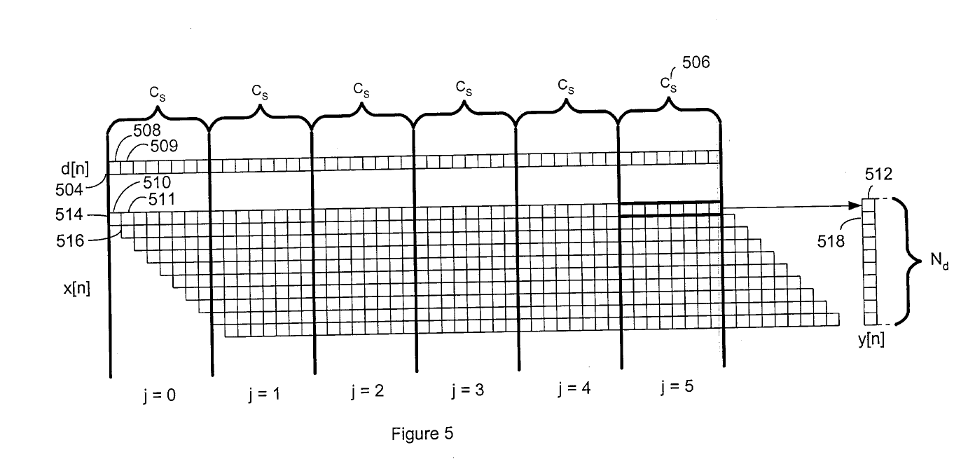

A conceptual illustration of this is shown in FIG. 5 for a uniform use of the received chips, with shifted code chips for each relative delay calculation. As shown, received chips 504 are broken into subcorrelation lengths Cₛ, which, for example, are 8 chips. Similarly, code chips 514 are broken into the subcorrelation lengths Cₛ. There is a relative delay of zero between received chips 504 and code chips 514. For the first subcorrelation length 506, a despread operation is performed on the received chips 504 and code chips 514 by multiplying each of the received chips by the corresponding code chips and summing these results together. The sum is added to prior results in, for instance, an accumulator register 512. For example, the first received chip 508 in the subcorrelation length is multiplied times the first code chip 510 in the subcorrelation length, second received chip 509 is multiplied times the second code chip 510, etc. The results of these multiplications are summed. The sum is added to any prior results stored in accumulator register 512 (which should be zero as this is the start of the operation for this delay). The value previously in accumulator register 512 is replaced with the result of this addition.

A despread operation is then performed for the next relative delay by providing a relative shift between the received chips and code chips, multiplying the corresponding received chips and code chips and summing the results. To do this for shifted code chips, as shown in FIG. 5, the received chips in subcorrelation length 506 are multiplied by a version of the code chips shifted by one chip 516 and the results are accumulated in a similar manner as with the undelayed version 514. This occurs for each of the delays to be evaluated N_{d}.

After all of the delays are evaluated for the first subcorrelation length, all of the delays for the next subcorrelation length are evaluated by the same process. This continues until the total number of subcorrelation lengths has been calculated.

Therefore, each of the N_{d} accumulators holds the correlation value for a relative delay. For example, accumulator 512 holds the correlation value for a 0 chip delay, while 518 holds the correlation value for a 1 chip delay. These N_{d} correlation values can then be unloaded and evaluated to determine the m number of relative delays with the highest correlation values to be used in the fingers of the Rake receiver.

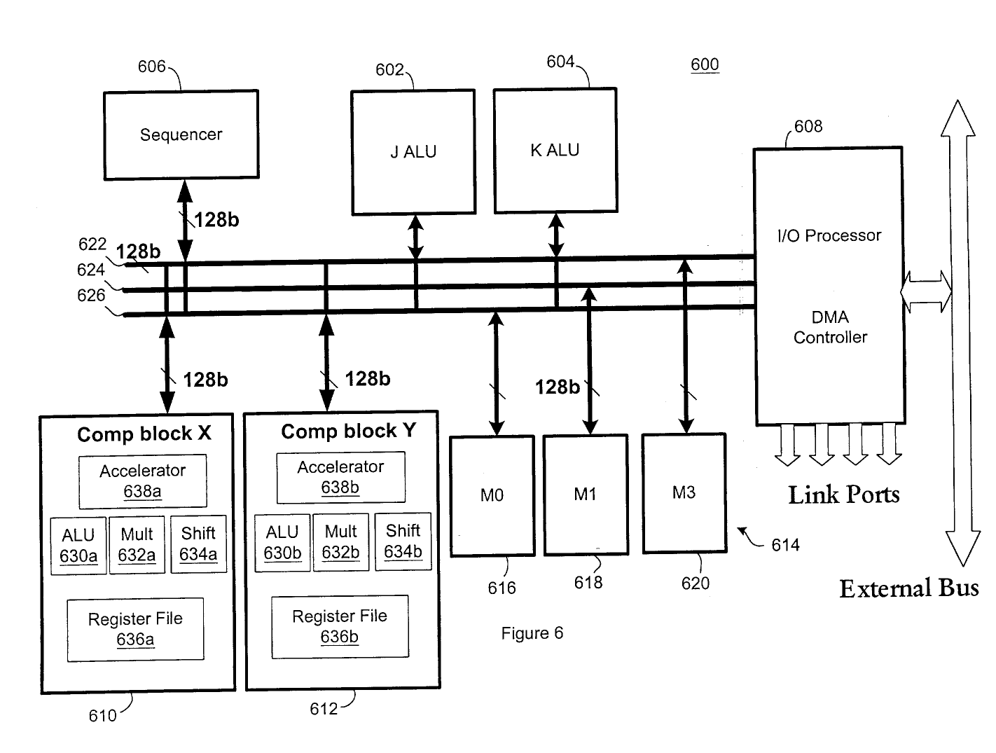

FIG. 6 illustrates an exemplary architecture of a DSP 600 for implementing the features of the present invention. DSP 600 comprises a sequencer 606, two integer units 602 and 604, an I/O processor 608, memory 614 and two computation blocks 610 and 612. These components are interconnected by three 128-bit busses 622, 624 and 626.

Memory 614 comprises a first memory bank 616, a second memory bank 618 and a third memory bank 620. First memory bank 616 is connected to bus 622. Second memory bank 618 is connected to bus 624. Third memory bank 620 is connected to bus 626. Each of the memory banks 616, 618 and 620 has a capacity of 64 K words of 32-bits each. Generally, single, dual or quad words can be accessed in a single cycle. Two 128-bit memory accesses are capable every cycle. Thus, in a single clock cycle, up to eight consecutive aligned words (a quad word) can be transferred to or from each memory bank via its corresponding 128-bit bus.

Program instructions are stored as words in one of the memory banks, while operands are stored as words in the other two memory banks. As a result, four instructions and eight operands can be transferred in a single cycle to each of the computation blocks 612 and 610 using quad word transfers.

Computation blocks 610 and 612 each include a register file 636, an arithmetic logic unit (ALU) 630, a multiplier/accumulator 632, a shifter 634 and an accelerator 638. These components of the computation blocks are capable of simultaneous execution of instructions and computation blocks 610 and 612 have pipelined architectures.

Accelerators 638 are provided in both of the computation blocks for enhanced processing when used in CDMA systems. Each accelerator 638a and 638b includes registers and circuitry for performing subcorrelation calculations for the path search. An accelerator, 638a or 638b, performs a despread operation for each relative delay over a subcorrelation length and adds the results to previous subcorrelation results in response to a single PATHDESPREAD instruction. Thus, by issuing multiple PATHDESPREAD instructions, the entire correlation block of the path search can be calculated in the DSP.

As described above, the calculations for the path search are multiply and accumulate operations on the received chips and the code chips. When processing is being performed, chips are stored in the registers in an accelerator. In one implementation, received chips are represented and stored digitally as 8 real bits (I) and 8 imaginary bits (Q), even though other sizes are able to be used depending upon sampling rates and other system concerns. Preferably, code chips are chosen to be ±1±j. This allows code chips to be represented and stored as two bits, one for the real portion (I) of the code chip and one for the imaginary portion (Q) of the code chip. If the bit is set, it represents a value of −1 and if it is cleared it represents a value of +1. Similarly, if the code chips are limited to values of +1, −1, +j, or −j, only two bits need to be used.

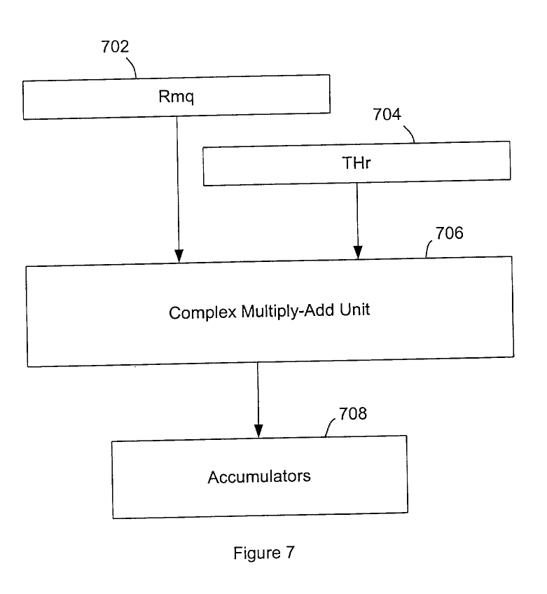

To perform the calculations in response to a PATHDESPREAD instruction, as shown in FIG. 7, an accelerator has a register Rmq 702, a register THr 704, complex multiply-add units 706 and N_{d} accumulation registers 708, one for each delay to be evaluated. Register Rmq is used to hold received chips or code chips in a uniform manner, depending on whether the system is designed to shift chip codes or shift received codes. Register THr is used to hold received chips or code chips in a shift accessible manner, also depending upon whether the system is designed to shift received chips or code chips. The following discussion describes a system in which code chips are shifted, and consequently, register THr is designed to hold and shift code chips, while register Rmq is designed to hold received chips in a uniform manner. One of skill in the art, however, will be capable of designing a similar system in which received chips are shifted based upon the foregoing discussion and the following description.

Register Rmq holds received chips, while register THr holds code chips. The number of received chips held by register Rmq is equal to the subcorrelation length. Similarly, Register THr holds a number of code chips equal to the subcorrelation length. Register THr also holds a number of additional code chips that is dependent on the number of delays. Complex multiply-add unit 706 multiplies chips in both registers over the subcorrelation length, and sums the results and adds the sum to previously accumulated values. This new result is then accumulated in one of the accumulator registers 708 corresponding to the delay being evaluated. For the implementation described, the PATHDESPREAD instruction has the following form:

Tr=PATHDESPREAD (Rmq, THr)

where Tr is accumulator register file 708.

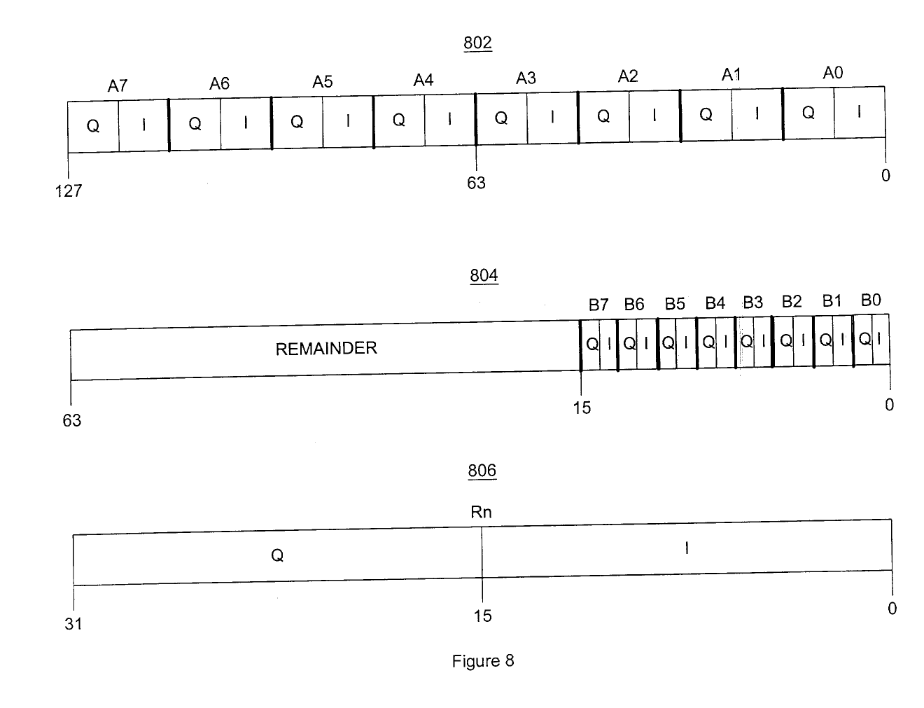

FIG. 8 illustrates structures of registers Rmq 802 and THr 804 and one accumulator register 806 that provides for calculations over a subcorrelation length of 8 chips and up to 32 delays. As shown, register Rmq is a 128-bit register that has portions A0-A7 to hold 8 received chips, which, as described, are preferably complex values composed of 2 bytes. The most significant 8 bits hold the imaginary portion (Q) and the least significant 8 bits hold the real portion (I).

The register THr has portions B0-B7 in the least significant 16 bits to hold 8 code chips as complex values composed of 2 bits. The code chips are composed of 2 bits because the chip codes are preferably limited to ±1±j, as previously described. The most significant bit represents the imaginary portion (Q) and the least significant bit represents the real portion (I). Each bit represents 1 when clear and −1 when set. Register THr is a 64-bit register with 48 remainder bits. The code chips to be multiplied times the received chips in register Rmq are loaded into the least significant bits. The twenty-four subsequent code chips are loaded into the 48-remainder bits when calculating 32 delays.

Accumulation register 806 is a 32-bit register. The 16 most significant bits hold the imaginary portion (Q) of the result of the multiply and accumulate operation on the received chips and code chips. The 16 least significant bits hold the real portion (I) of the result of the multiply and accumulate operation on the received chips and code chips. For each delay calculation there is an accumulation register.

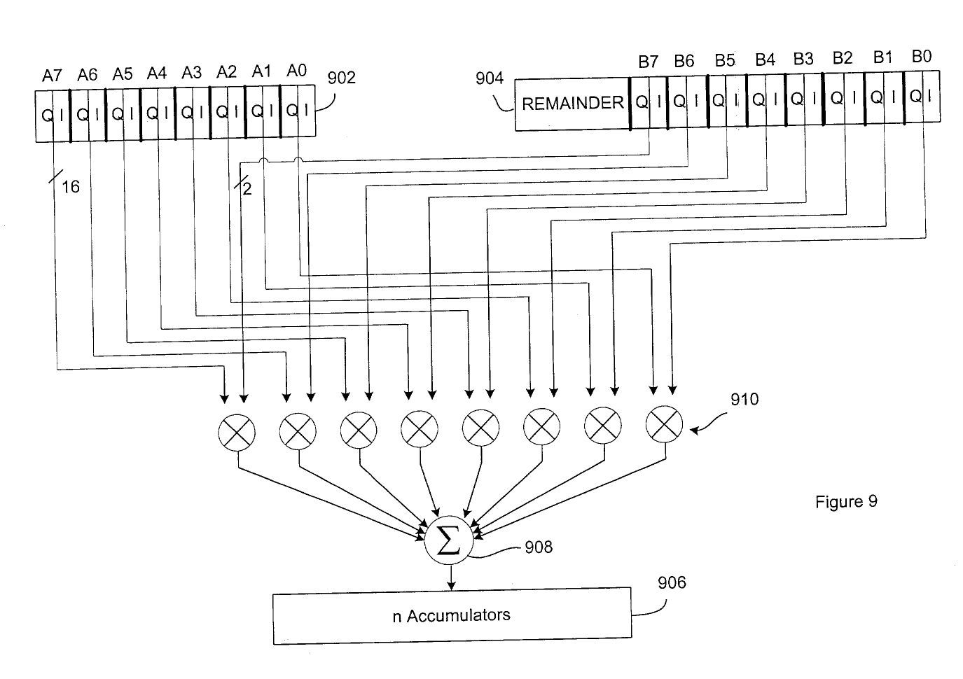

FIG. 9 illustrates a flow diagram for a single despread operation performed as part of the PATHDESPREAD instruction. As shown, each received chip stored in register Rmq 902 is multiplied by a corresponding code chip in the 16 least significant bits of register THr 906 using complex multipliers 910. For example, the received chip in A0 is multiplied by B0. The results of these multiplications are added by complex adder 908, with the result of this add operation stored in one of the n accumulator registers 906. Thus, a single despread operation calculates the function:

$${Result}_{real} = {\sum }_{k = 0}^{7} An ( I ) * Bn ( I ) - An ( Q ) * Bn ( Q ) \qquad ( 5 )$$

which is stored in the real portion (I) of one of the accumulator registers 906, and:

$${Result}_{imaginary} = {\sum }_{k = 0}^{7} An ( I ) * Bn ( Q ) + An ( Q ) * Bn ( I ) \qquad ( 6 )$$

which is stored in the imaginary portion (Q) of one of the n accumulator registers 906.

By limiting the chipping codes to ±1±j, the complex multiplications can be executed by the DSP as a multiplication by a positive or negative 1. This allows for the preferable implementation of this complex multiplication as a passing of a chip or the negation of a chip. For instance, when the chipping code is 1+−j, the real portion is 1 and the imaginary portion is −1. Any portion of a received chip multiplied by the real part (Bn(I)) in equations (5) or (6) stays the same, while any portion of a received chip multiplied by the imaginary part (Bn(Q)) in equations (5) or (6) is negated.

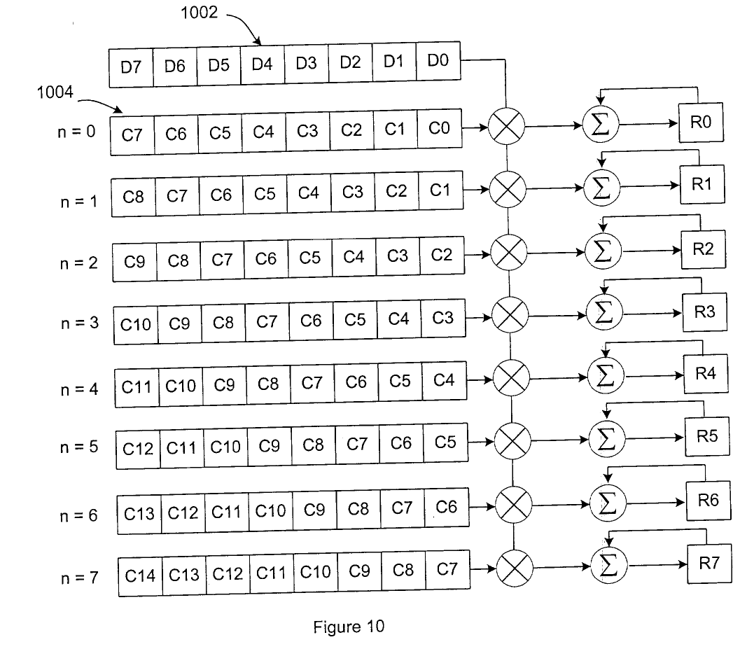

In response to a PATHDESPREAD instruction, a despread operation is performed for each delay to be calculated, with the register THr shifted by 1 code chip for each despread operation. FIG. 10 illustrates this for the case of 8 delays. Received chips D0-D7 are loaded into the A0-A7 portions of register Rmq 1002. Code chips C0-C7 are loaded into the B0-B7 portions of register THr 1004. Subsequent code chips C8-C14 are loaded into the remainder portion of register THr. In practice, even though C15 is not needed for 8 delays, it would be loaded because, in the exemplary DSP architecture as described, the code segments C0-C15 would likely be stored and loaded into register THr as a single 32-bit word.

When the PATHDESPREAD instruction is issued, received chips D0-D7 are despread against code chips C0-C7 by multiplying the corresponding chips in each, summing the results, and adding the summed results to the value previously in accumulator R0 (if this is the first subcorrelation, the value in R0 is 0). The results of the addition are then stored in accumulation register R0.

The code chips are then delayed by 1 chip (n=1) by shifting the register THr by 1 code chip and the despread operation is performed again. Thus, to calculate the correlation for a delay of 1 chip, the received chips D0-D7 are despread against the code chips C1-C8 by multiplying the corresponding chips, summing the results and adding the summed results to the value previously in accumulator R1 (if this is the first subcorrelation, the value in R1 is 0). The result of the addition is then stored in accumulation register R1. This continues until all 8 delays (n=0 to n=7) have been calculated and stored.

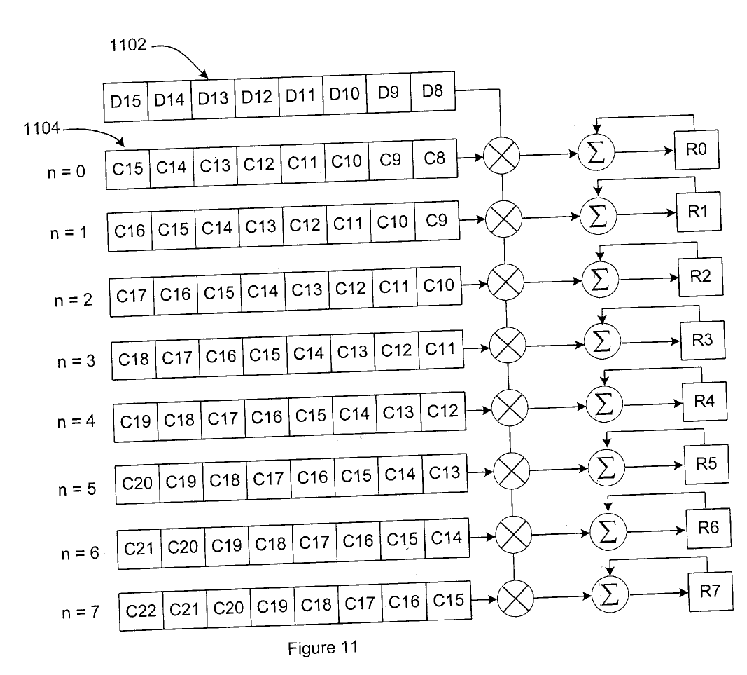

To perform the next subcorrelation, a second PATHDESPREAD instruction is issued. As illustrated in FIG. 11, to perform the next subcorrelation, received chips D8-D15 are loaded into the A0-A7 portions of register Rmq 1102. Code chips C8-C15 are loaded into the B0-B7 portions of register THr 1104. Subsequent code chips C16-C22 are loaded into the remainder portion of register THr. As described previously, even though C23 is not needed for 8 delays, it would be loaded because, in the exemplary DSP architecture as described, the code segments C16-C23 would likely be stored and loaded into register THr as a single 32-bit word.

When the PATHDESPREAD instruction is issued, received chips D8-D15 are despread against code chips C8-C15 by multiplying the corresponding chips in each, summing the results, and adding the summed results to the value previously in accumulator R0 (which holds the result of the previous PATHDESPREAD instruction). The results of the addition is then stored in accumulation register R0.

The code chips are then delayed by 1 chip (n=1) by shifting the register THr by 1 code chip and the despread operation is performed again. Thus, to calculate the correlation for a delay of 1 chip, the received chips D0-D7 are despread against the code chips C9-C16 by multiplying the corresponding chips, summing the results and adding the summed results to the value previously in accumulator R1 (which holds the value of the previous PATHDESPREAD instruction). The result of the addition is then stored in accumulation register R1. This continues until all 8 delays (n=0 to n=7) have been calculated and stored.

Thus, the entire correlation block of the path search can be performed in a DSP by issuing multiple PATHDESPREAD instructions until all of the subcorrelations in the correlation block have been calculated. Unloading the correlation values and determining the m highest gives the highest quality multi-path components. The corresponding delays can then be used in an m finger Rake receiver.

Although the present invention has been shown and described with respect to several preferred embodiments thereof, various changes, omissions and additions to the form and detail thereof, may be made therein, without departing from the spirit and scope of the invention. For instance, the PATHDESPREAD instruction can be modified to provide options that are beneficial for the DSP programmer. The options could include CLR, ext, and CUT #imm. In this case, the PATHDESPREAD would then have the form:

Tr=PATHDESPREAD (Rmq, THr) (CLR) (ext) (CUT #imm)

The option CLR would clear the accumulators before summing. The option ext would change the data size. For example, ext can be implemented to change the received chip size from being 16 bit complex elements (as in the implementation described above) to 4 32 bit complex elements, 16 low bits for the real part and 16 high bits for the imaginary part. Thus, the data chips would be composed of 4 32 bit complex elements rather than 8 16 bit complex elements. Each result would then be stored in a dual register (64 bits). The code chip size would remain identical in option ext, but the number of elements that are relevant and used in the calculations would change. In the preferred implementation, some key parameters in play include: the number of delays and the size of the operands. In a specific implementation, support for two possible sets of choices is provided. The first set has 16 delays with an operand size of 8 bit real and 8 bit imaginary (no ext). The second set has 8 delays with an operand size of 16 bit real and 16 bit imaginary (ext). The following table (Table 1) summarizes the relationship between the number of delays, the operand size, and the code bits used.

TABLE 1

| | Number of | | | |
|---|---|---|---|---|
| Set | Delays | Operand Size | Code Bits Used | Ext Option |
| 1 | 16 | 8 | C0-C22 | no ext |
| 2 | 8 | 16 | C0-C10 | Ext |

The option CUT #imm, where imm is a 6 bit immediate or R, would define a part of the multiplications that are not included in the sum. It is defined by which group of code chips is not used in the multiplication. The CUT operation provides the ability to set all the multiplication operations associated with the code above or below a certain cut point to zero in order to compensate for the staircase effect of FIG. 5. Decode of CUT option is CUT value represented in two's complement 6 bits (example—cut 20 is 0b010100, and cut −14 is 0b110010). “CUT R” means that the number in an options register, CMCTL, controls the cut number. The list below demonstrates the parts not used for a given cut number in an implementation using 16 delays (for 16 delays, C0-C21 are used in the calculations). The list refers to both cut by immediate or cut by register.

Default—all multiplications are executed. (cut field=0×00)

Cut −1—Multiplications under C1 are ignored (cut field 0×3F)

Cut −2—Multiplications under C2 are ignored (cut field 0×3E)

Cut −3—Multiplications under C3 are ignored (cut field 0×3D)

Cut −4—Multiplications under C4 are ignored (cut field 0×3C)

Cut −5—Multiplications under C5 are ignored (cut field 0×3B)

Cut −6—Multiplications under C6 are ignored (cut field 0×3A)

Cut −7—Multiplications under C7 are ignored (cut field 0×39)

Cut −8—Multiplications under C8 are ignored (cut field 0×38)

Cut −9—Multiplications under C9 are ignored (cut field 0×37)

Cut −10—Multiplications under C10 are ignored (cut field 0×36)

Cut −11—Multiplications under C11 are ignored (cut field 0×35)

Cut −12—Multiplications under C12 are ignored (cut field 0×34)

Cut −13—Multiplications under C13 are ignored (cut field 0×33)

Cut −14—Multiplications under C14 are ignored (cut field 0×32)

Cut −15—Multiplications under C15 are ignored (cut field 0×31)

Cut −16—Multiplications under C16 are ignored (cut field 0×30)

Cut −17—Multiplications under C17 are ignored (cut field 0×2F),

Cut −18—Multiplications under C18 are ignored (cut field 0×2E)

Cut −19—Multiplications under C19 are ignored (cut field 0×2D)

Cut −20—Multiplications under C20 are ignored (cut field 0×2C)

Cut −21—Multiplications under C21 are ignored (cut field 0×2B)

Cut −22—Multiplications under C22 are ignored (cut field 0×2A)

Cut 1—Multiplications with C1 and over are ignored (cut field 0×01)

Cut 2—Multiplications with C2 and over are ignored (cut field 0×02)

Cut 3—Multiplications with C3 and over are ignored (cut field 0×03)

Cut 4—Multiplications with C4 and over are ignored (cut field 0×04)

Cut 4—Multiplications with C5 and over are ignored (cut field 0×05)

Cut 6—Multiplications with C6 and over are ignored (cut field 0×06)

Cut 7—Multiplications with C7 and over are ignored (cut field 0×07)

Cut 8—Multiplications with C8 and over are ignored (cut field 0×08)

Cut 9—Multiplications with C9 and over are ignored (cut field 0×09)

Cut 10—Multiplications with C10 and over are ignored (cut field 0×0A)

Cut 11—Multiplications with C11 and over are ignored (cut field 0×0B)

Cut 12—Multiplications with C12 and over are ignored (cut field 0×0C)

Cut 13—Multiplications with C13 and over are ignored (cut field 0×0D)

Cut 14—Multiplications with C14 and over are ignored (cut field 0×0E)

Cut 15—Multiplications with C15 and over are ignored (cut field 0×0F)

Cut 16—Multiplications with C16 and over are ignored (cut field 0×10)

Cut 17—Multiplications with C17 and over are ignored (cut field 0×11)

Cut 18—Multiplications with C18 and over are ignored (cut field 0×12)

Cut 19—Multiplications with C19 and over are ignored (cut field 0×13)

Cut 20—Multiplications with C20 and over are ignored (cut field 0×14)

Cut 21—Multiplications with C21 and over are ignored (cut field 0×15)

Cut 22—Multiplications with C22 is ignored (cut field 0×16)

For the option (ext), the cut combinations are:

Default—all multiplication is executed. (cut field=0×00)

Cut −1—Multiplications under C1 are ignored (cut field 0×3F)

Cut −2—Multiplications under C2 are ignored (cut field 0×3E)

Cut −3—Multiplications under C3 are ignored (cut field 0×3D)

Cut −4—Multiplications under C4 are ignored (cut field 0×3C)

Cut −5—Multiplications under C5 are ignored (cut field 0×3B)

Cut −6—Multiplications under C6 are ignored (cut field 0×3A)

Cut −7—Multiplications under C7 are ignored (cut field 0×39)

Cut −8—Multiplications under C8 are ignored (cut field 0×38)

Cut −9—Multiplications under C9 are ignored (cut field 0×37)

Cut −10—Multiplications under C10 are ignored (cut field 0×36)

Cut 1—Multiplications with C1 and over are ignored (cut field 0×01)

Cut 2—Multiplications with C2 and over are ignored (cut field 0×02)

Cut 3—Multiplications with C3 and over are ignored (cut field 0×03)

Cut 4—Multiplications with C4 and over are ignored (cut field 0×04)

Cut 5—Multiplications with C5 and over are ignored (cut field 0×05)

Cut 6—Multiplications with C6 and over are ignored (cut field 0×06)

Cut 7—Multiplications with C7 and over are ignored (cut field 0×07)

Cut 8—Multiplications with C8 and over are ignored (cut field 0×08)

Cut 9—Multiplications with C9 and over are ignored (cut field 0×09)

Cut 10—Multiplications with C10 is ignored (cut field 0×0A).

Of course, other modifications, omission, or additions within the spirit and scope of the present inventions will be envisioned by one of skill in the art. Thus, it will be understood that there is no intent to limit the invention by the present disclosure, but rather, the present disclosure is to be considered as an exemplification of the principles of the invention and the associated functional specifications for its construction.

What is claimed is:

1. A digital signal processor that performs path search calculations for a Rake receiver in a CDMA system, the digital signal processor comprising:
a first storage area to hold received chips;
a second storage area to hold code chips;
wherein the digital signal processor, in response to a single instruction, performs multiple despread operations on the received chips and the code chips, the received chips and the code chips shifted relative to each other for each of the despread operations.

2. The digital signal processor of claim 1, wherein the code chips are limited to values of ±1±j.

3. The digital signal processor of claim 2, wherein the code chips are represented as two bits comprising one real bit and one imaginary bit.

4. The digital signal processor of claim 3, wherein a set code bit represents a value of −1 and a clear code bit represents a value of +1.

5. The digital signal processor of claim 3, wherein complex multiplications of the despread operations are performed by passing or negating received chips.

6. The digital signal processor of claim 1, wherein the code chips are limited to values of +1, −1, +j, or −j.

7. The digital signal processor of claim 1, wherein received chips are represented as 16 bits.

8. The digital signal processor of claim 7, wherein the received chips are represented by 8 real, bits and 8 imaginary bits.

9. The digital signal processor of claim 1, wherein received chips are represented as 32 bits.

10. The digital signal processor of claim 9, wherein the received chips are represented by 16 real bits and 16 imaginary bits.

11. The digital signal processor of claim 1, wherein the code chips have a spreading factor divisible by 8.

12. A digital signal processor that performs path search calculations for a Rake receiver in a CDMA system, the digital signal processor comprising:
a first storage area to hold complex values representative of received chips in a CDMA system;
a second storage area to hold complex values representative of code chips in a CDMA system;
a complex multiply-add unit to multiply complex values in the first storage area times complex values in the second storage area and to sum the results; and
wherein the multiply-add unit performs a plurality of multiplications on the complex values in the first and second storage areas and either the first or second storage area shifts the complex values stored therein after each multiplication.

13. The digital signal processor of claim 12, wherein said complex multiply-add unit sets all multiplications above or below a certain cut point to zero.

14. The digital signal processor of claim 12, wherein said complex multiply-add unit receives instructions regarding which of said multiplied complex values is to be included in said sum.

15. The digital signal processor of claim 12, wherein the code chips are limited to the values of ±1±j.

16. The digital signal processor of claim 15, wherein the code chips are represented as two bits comprising one real bit and one imaginary bit.

17. The digital signal processor of claim 16, wherein a set code bit represents a value of −1 and a clear code bit represents a value of +1.

18. The digital signal processor of claim 16, wherein the multiplications are performed by passing or negating received chips.

19. The digital signal processor of claim 12, wherein the code chips are limited to values of +1, −1, +j, or −j.

20. The digital signal processor of claim 12, wherein received chips are represented as 16 bits.

21. The digital signal processor of claim 20, wherein the received chips are represented by 8 real bits and 8 imaginary bits.

22. The digital signal processor of claim 12, wherein received chips are represented as 32 bits.

23. The digital signal processor of claim 22, wherein the received chips are represented by 16 real bits and 16 imaginary bits.

24. The digital signal processor of claim 12, wherein the code chips have a spreading factor divisible by 8.

25. A method of processing a CDMA signal in a digital signal processor to perform path search calculations for a Rake receiver, the method comprising the step of:
in response to a single instruction, performing multiple despread operations on received chips and code chips in a CDMA system, where the received chips and the code chips are shifted relative to each other for each of the despread operations.

26. The digital signal processor of claim 25, wherein the code chips are values of +1+j.

27. The digital signal processor of claim 26, wherein the code chips are represented as two bits comprising one real bit and one imaginary bit.

28. The digital signal processor of claim 27, wherein a set code bit represents a value of −1 and a clear code bit represents a value of +1.

29. The digital signal processor of claim 27, wherein complex multiplications of the despread operations are performed by passing or negating received chips.

30. The digital signal processor of claim 25, wherein the code chips are limited to values of +1, −1, +j, or −j.

31. The digital signal processor of claim 25, wherein received chips are represented as 16 bits.

32. The digital signal processor of claim 31, wherein the received chips are represented by 8 real bits and 8 imaginary bits.

33. The digital signal processor of claim 25, wherein received chips are represented as 32 bits.

34. The digital signal processor of claim 33, wherein the received chips are represented by 16 real bits and 16 imaginary bits.

35. The digital signal processor of claim 25, wherein the code chips have a spreading factor divisible by 8.

36. A method of using a digital signal processor for performing path search calculations for a Rake receiver in a CDMA system, the method comprising:
issuing one or more instructions to load a register with received chip values;
issuing one or more instructions to cause a digital signal processor to load a register with code chip values; and
issuing a single instruction to despread the received chip values against the code chip values multiple times with a relative shift between the received chips and code chips each time the received chips are despread against the code chips.

37. The digital signal processor of claim 36, wherein the code chips are values of ±1±j.

38. The digital signal processor of claim 37, wherein the code chips are represented as two bits comprising one real bit and one imaginary bit.

39. The digital signal processor of claim 38, wherein a set code bit represents a value of −1 and a clear code bit represents a value of +1.

40. The digital signal processor of claim 38, wherein complex multiplications of the despreads are performed by passing or negating received chips.

41. The digital signal processor of claim 36, wherein the code chips are limited to values of +1, −1, +j, or −j.

42. The digital signal processor of claim 36, wherein received chips are represented as 16 bits.

43. The digital signal processor of claim 42, wherein the received chips are represented by 8 real bits and 8 imaginary bits.

44. The digital signal processor of claim 36, wherein received chips are represented as 32 bits.

45. The digital signal processor of claim 44, wherein the received chips are represented by 16 real bits and 16 imaginary bits.

46. The digital signal processor of claim 36, wherein the code chips have a spreading factor divisible by 8.

47. A digital signal processor comprising:
a first storage area to hold a first set of complex values;
a second storage area to hold a second set complex values;
a complex multiply-add unit to multiply complex values in the first storage area times complex values in the second storage area and to sum the results; and
wherein the multiply-add unit performs a plurality of multiplications on the complex values in the first and second storage areas and either the first or second storage area shifts the complex values stored therein after each multiplication.

48. A digital signal processor of claim 47, wherein said complex multiply-add unit sets all multiplications above or below a certain cut point to zero.

49. The digital signal processor as per claim 47 wherein said complex multiply-add unit receives instructions regarding which of said multiplied complex values is to be included in said sum.

50. The digital signal processor as per claim 47 wherein said digital signal processor works in conjunction with a Rake receiver of a CDMA system and said first set of complex values are representative of received chips and the second set of complex values are representative of code chips.

51. The digital signal processor of claim 50, wherein the code chips are limited to the values of ±1±j.

52. The digital signal processor of claim 51, wherein the code chips are represented as two bits comprising one real bit and one imaginary bit.

53. The digital signal processor of claim 52, wherein a set code bit represents a value of −1 and a clear code bit represents a value of +1.

54. The digital signal processor of claim 52, wherein the multiplications are performed by passing or negating received chips.

55. The digital signal processor of claim 50, wherein the code chips are limited to values of +1, −1+j, or −j.

56. The digital signal processor of claim 50, wherein received chips are represented as 16 bits.

57. The digital signal processor of claim 56, wherein the received chips are represented by 8 real bits and 8 imaginary bits.

58. The digital signal processor of claim 50, wherein received chips are represented as 32 bits.

59. The digital signal processor of claim 58, wherein the received chips are represented by 16 real bits and 16 imaginary bits.

60. The digital signal processor of claim 50, wherein the code chips have a spreading factor divisible by 8.
